(19) United States
(12) Patent Application Publication
(10) Pub. No.: US 2013/0158763 A1
(43) Pub. Date: Jun. 20, 2013

(54) CONTROL DEVICE OF VEHICLE-ONBOARD ELECTRIC SOURCE

(71) Applicant: MAZDA MOTOR CORPORATION, Hiroshima (JP)

(72) Inventors: Masamitsu Yuhara, Hiroshima-city (JP); Kazuya Kotani, Hiroshima-city (JP); Hiroki Fujita, Hiroshima-city (JP)

(73) Assignee: MAZDA MOTOR CORPORATION, Hiroshima (JP)

(21) Appl. No.: 13/718,786

(22) Filed: Dec. 18, 2012

(30) Foreign Application Priority Data
Dec. 19, 2011 (JP) 2011-276919

(51) Int. Cl. B60L 15/20

(52) U.S. Cl. CPC B60L 15/20
USPC 701/22

(57) ABSTRACT

There are provided a deterioration degree determining module configured to determine whether or not a real-deterioration degree exceeds an estimated-deterioration degree by comparing the real-deterioration degree detected by a real-deterioration degree detecting module and the estimated-deterioration degree memorized by an estimated-deterioration degree memorizing module, and an upper-limit voltage controlling module configured to set an upper-limit voltage of charging of a capacitor by a generator at a limit voltage which is lower than a specified voltage and corresponds to an excess degree of the real-deterioration degree over the estimated-deterioration degree when it is determined that the real-deterioration degree exceeds the estimated-deterioration degree.

### BACKGROUND OF THE INVENTION

The present invention relates to a control device of a vehicle-onboard electric source which comprises a generator and a capacitor.

Japanese Patent Laid-Open Publication No. 2010-160091, for example, discloses a working machine with an electromotive machine installed thereto, in which an excess kinetic energy generated by the electromotive machine is converted to an electric energy and stored at a capacitor. This capacitor deteriorates through its long-term use with charging and discharging repeated. Accordingly, this patent publication discloses determination of a deterioration degree of the capacitor by using both the internal resistance and the capacitance of the capacitor in order to improve the accuracy of the determination.

Meanwhile, the fuel economy (gas millage) of a vehicle, such as automotive vehicles, can be improved by configuring such that a quick-chargeable capacitor is used as part of an electric source, and an electric energy (recovered electricity) from an alternator (generator) during declaration of the vehicle is charged (stored) and then discharged to an electric load of the vehicle. Herein, the efficiency of the capacitor's charging as well as the storage capacitance can be properly increased by charging with a high voltage of the generator, thereby improving the fuel economy more.

However, the capacitor's charging with the high voltage quickens the deterioration (decrease of the capacitance, particularly) of the capacitor, compared to the capacitor's charging with a low voltage, so that there is a concern that the capacitor may not function properly until the term of guarantee has expired. In this case, no improvement of the fuel economy may be expected.

Herein, while the deterioration degree of the capacitor can be determined according to the above-described patent document, this patent document fails to disclose how to control the use manner of the capacitor based on this determination, so that it may be difficult to improve the durability of the capacitor.

### SUMMARY OF THE INVENTION

The present invention has been devised in view of the above-described matters, and an object of the present invention is to provide a control device of a vehicle-onboard electric source which can improve the fuel economy of the vehicle as well as the durability of the capacitor.

According to the present invention, there is provided a control device of a vehicle-onboard electric source, comprising a generator driven by an engine to generate electricity, a capacitor storing an electric energy from the generator during declaration of a vehicle to discharge the electricity to an electric load of the vehicle, and a controller including an estimated-deterioration degree memorizing module configured to previously memorize an estimated-deterioration degree of the capacitor against a use term, a real-deterioration degree detecting module configured to detect a real-deterioration degree of the capacitor at a specified timing of the use term of the capacitor, a deterioration degree determining module configured to determine whether or not the real-deterioration degree exceeds the estimated-deterioration degree by comparing the real-deterioration degree detected by the real-deterioration degree detecting module with the estimated-deterioration degree memorized by the estimated-deterioration degree memorizing module, and an upper-limit voltage controlling module configured to set an upper-limit voltage of charging of the capacitor by the generator at a limit voltage which is lower than a specified voltage and corresponds to an excess degree of the real-deterioration degree over the estimated-deterioration degree when it is determined by the deterioration degree determining module that the real-deterioration degree exceeds the estimated-deterioration degree.

According to the present invention, since the upper-limit voltage of charging of the capacitor is set at the limit voltage lower than the specified voltage when the real-deterioration degree exceeds the estimated-deterioration degree, that is—when it is determined that the deterioration of the capacitor may occur before the estimated deterioration, the deterioration of the capacitor can be delayed after the estimated deterioration. Further, since the limit voltage is a voltage corresponding to the excess degree of the real-deterioration degree over the estimated-deterioration degree, it can be controlled at an appropriate voltage enabling the capacitor's deterioration to be delayed after the estimated deterioration, without being lowered excessively. Accordingly, the capacitor's deterioration can be delayed, keeping a properly-high efficiency of the charging of the capacitor. Herein, the above-described specified voltage can be properly set at a voltage enabling the capacitor's deterioration to be quickened considerably when the upper-limit voltage exceeds the specified voltage.

According to an embodiment of the present invention, the upper-limit voltage controlling module is configured to set the upper-limit voltage at the specified voltage when it is determined by the deterioration degree determining module that the real-deterioration degree does not exceed the estimated-deterioration degree. Thereby, setting at the specified voltage higher than the limit voltage becomes possible, so that the charging efficiency of the capacitor can be increased.

According to another embodiment of the present invention, the control device further comprises a capacitor-temperature detector to detect a temperature of the capacitor, wherein the upper-limit voltage controlling module is configured to change the limit voltage in accordance with the temperature detected by the capacitor-temperature detector when it is determined by the deterioration degree determining module that the real-deterioration degree exceeds the estimated-deterioration degree. In general, the capacitor's deterioration tends to be quickened when the temperature of the capacitor is higher. Therefore, even when the capacitor's temperature is high, the limit voltage can be a more appropriate voltage enabling the capacitor's deterioration to be surely delayed after the estimated deterioration by changing the limit voltage in accordance with the capacitor's temperature.

According to another embodiment of the present invention, the upper-limit voltage controlling module has a characteristic map of the specified voltage according to the temperature of the capacitor, and is configured, when it is determined by the deterioration degree determining module that the real-deterioration degree exceeds the estimated-deterioration degree, to create a characteristic map of the limit voltage according to the temperature of the capacitor from the characteristic map of the specified voltage in accordance with the excess degree of the real-deterioration degree over the estimated-deterioration degree, and change the limit voltage based on the temperature detected by the capacitor-temperature detector and the characteristic map of the limit voltage. Thereby, both the specified voltage and the limit voltage can be set easily at the appropriate voltages corresponding to the capacitor's temperature by the characteristic maps.

According to another embodiment of the present invention, the real-deterioration degree detecting module is configured to repeat the detection of the real-deterioration degree of the capacitor every a specified period of time, the deterioration degree determining module is configured to conduct the determination as to whether or not the real-deterioration degree exceeds the estimated-deterioration degree at each time of the detection of the real-deterioration degree of the capacitor by the real-deterioration degree detecting module, and the upper-limit voltage controlling module is configured to set the upper-limit voltage at the specified voltage when, in a previous determination, it is determined by the deterioration degree determining module that the real-deterioration degree exceeds the estimated-deterioration degree, thereby setting the upper-limit voltage at the limit voltage, and then, in a present determination, it is determined by the deterioration degree determining module that the real-deterioration degree does not exceed the estimated-deterioration degree. That is, there is a case in which even when it is determined by the deterioration degree determining module that the real-deterioration degree exceeds the estimated-deterioration degree in the previous determination, it is determined that the real-deterioration degree does not exceed the estimated-deterioration degree in the present determination by setting the upper-limit voltage at the limit voltage, thereby delaying the capacitor's deterioration after the estimated deterioration. In this case, by setting the upper-limit voltage at the limit voltage, the efficiency of the capacitor's charging can be increased, so that the fuel economy of the vehicle can be improved.

Other features, aspects, and advantages of the present invention will become apparent from the following description which refers to the accompanying drawings.

### BRIEF DESCRIPTION OF THE DRAWINGS

FIG. 1 is a plan view showing a structure of a vehicle, to which a control device of a vehicle-onboard electric source according to an embodiment of the present invention is installed.

FIG. 2 is a schematic view showing constitution of the control device of the vehicle-onboard electric source.

FIG. 3 is a graph showing a characteristic map of a specified voltage and a limit voltage for a temperature of a capacitor.

FIG. 4 is a graph showing an example of a change of the capacitance (real-deterioration degree) of a capacitor caused by an operation of a controller.

### DETAILED DESCRIPTION OF THE INVENTION

Hereafter, a preferred embodiment of the present invention will be described specifically referring to the accompanying drawings.

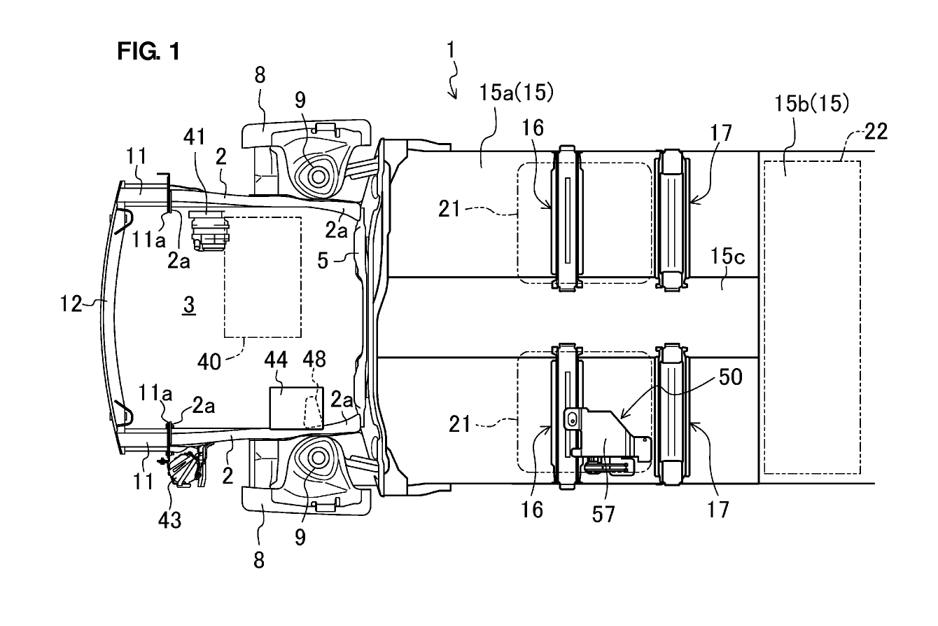

FIG. 1 shows a structure of a vehicle 1, to which a control device of a vehicle-onboard electric source according to an embodiment of the present invention is installed. The left side in FIG. 1 corresponds to the left side of the vehicle 1. Hereinafter, front, rear, left, right, upper and lower regarding the vehicle 1 will be simply referred to as front, rear, left, right, upper and lower.

A pair of right-and-left front side frames 2 which extends longitudinally is arranged at both end portions, in a vehicle width direction (a lateral direction), of a front portion of the vehicle 1. A space between the front side frames 2 is an engine room 3 where an engine 40 is provided. A rear portion of each of the front side frames 2 is a kick portion 2a, the level of which lowers gradually toward a rear side. A dash panel 5 which partitions a vehicle compartment from the engine room 3 is provided to extend in the vehicle width direction and a vertical direction substantially at the same longitudinal position as the kick portion 2a.

A pair of suspension towers 9 is provided on the outside, in the vehicle width direction, of the right-and-left front side frames 2. Respective upper end portions of the right-and-left suspension towers 9 are respectively fixed to a pair of right-and-left apron reinforcement members 8 which extends longitudinally, and lower end portions of the suspension towers 9 are respectively fixed to the front side frames 2.

Crash cans 11 are provided at respective front ends of the right-and-left front side frames 2. A flange portion 2a is formed at the front end of each of the front side frames 2, and a flange portion 11a is formed at a rear end of each of the crash cans 11. These flange portions 2a, 11a is fixed to each other by a fastening member, not illustrated, (bolts and nuts).

Front ends of the right-and-left crash cans 11 are fastened to respective right-and-left both end portions of a bumper beam 12 which extends in the vehicle width direction. The bumper beam 12 is provided inside a front bumper, not illustrated, provided at a front end portion of the vehicle 1 and receives a collision load in a head-on collision of the vehicle 1. The right-and-left crash cans 11 come to crush longitudinally when the bumper beam 12 receives the collision load from the front in the head-on collision of the vehicle 1, so as to perform impact absorption. Herein, the impact absorption can be properly performed only by the crash cans 11 crushing in a light collision. In a heavy collision, however, the impact absorption can be properly performed by both the crash cans 11 crushing and the front side frames 2 longitudinally crushing.

A lower end portion of the dash panel 5 is connected to a front end portion of the floor panel 15 which forms a bottom face of the vehicle compartment. The floor panel 15 comprises a front floor portion 15a and a rear floor portion 15b which is positioned in back of the front floor panel 15a and rises from a rear end of the front floor portion 15a to a higher position than the front floor portion 15a.

Two right-and-left front seats 21 (one is a driver's seat and the other is a passenger's seat (assistant seat)) are arranged side by side in the vehicle width direction on the front floor portion 15a of the floor panel 15. A rear seat 22 is arranged in back of the front seats 21 on the floor panel 15 (i.e., on the rear floor portion 15b). A rear-side portion of the front floor portion 8a located in back of the front seats 21 (i.e., a portion between the front seats 21 and the rear seat 22) is a foot-placing space for a passenger seated in the rear seat 22.

At a central portion, in the vehicle width direction, of the front floor portion 15a of the floor panel 15 (between the right and left front seats 21) is formed a tunnel portion 15c. Further, a pair of front cross members 16 and a pair of rear cross members 17 are arranged on an upper face of the front floor portion 15a on both sides of the tunnel portion 15c. These cross members 16, 17 extend in the vehicle width direction, respectively, and are located away from each other in the vehicle longitudinal direction.

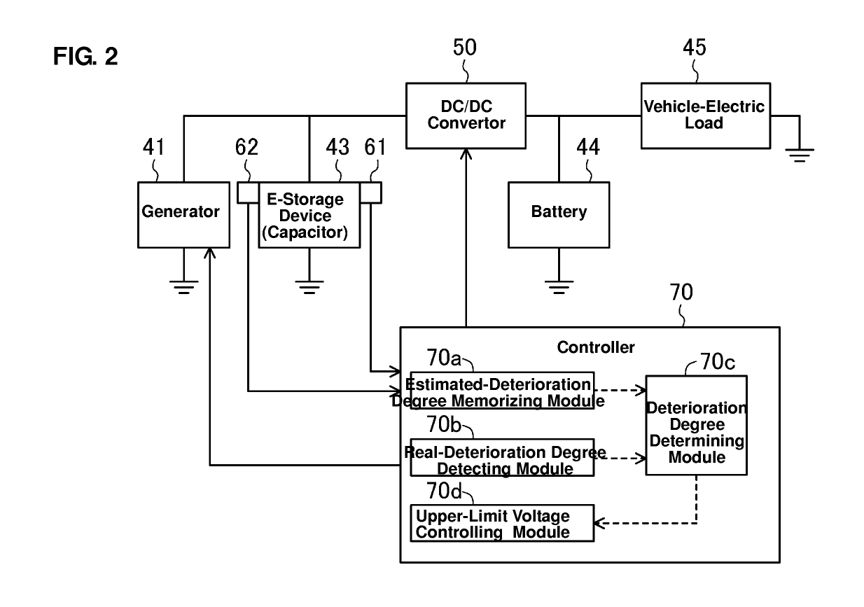

A generator 41 (alternator) which is driven by the engine 40 and generates the electricity is provided at a right-side portion of the front portion of the engine 40 in the engine room 3. While the generator 41 is rotated by a crankshaft of the engine 40 via a belt all the time during an operation of the engine 40, its state is switchable between an electricity-generation state in which the generator 41 is driven by the engine 40 and generates the electricity and a non-electricity-generation state in which the generator 41 is driven by the engine 40 but does not generate the electricity by a control of a controller 70 (see FIG. 2). Further, the voltage of the generated electricity (electric power) by the generator 41 in the electricity-generation state is changeable by the control of a controller 70.

An electricity-storage device 43 is provided on the outside (left side), in the vehicle width direction, of the left front side frame 2, that is—at a position near a left-outside portion of the engine room 3 and between a front wheel and the crash can 11 in the longitudinal direction. This electricity-storage device 43 is comprised of a capacitor. The electricity-storage device 43 is supported at the flange portion 2a of the left front side frame 2 or a flange portion 11a of the left crash can 11 (a flange portion connected to the flange portion 2a of the left front side frame 2). Thus, the electricity-storage device 43 may not receive any improper thermal influence from the engine 40 so as to be cooled efficiently by vehicle-traveling air. Further, the electricity-storage device 43 may not block the impact-absorption performance of the crash cans 15 in the head-on collision (light collision) of the vehicle 1 as well as the impact-absorption performance of the front side frames 2 in the head-on collision (heavy collision) of the vehicle 1.

A battery 44 which is comprised of a normal lead-acid battery is provided at a left-rear side portion in the engine room 3. This battery 44 is supported at the left front side frame 2 via a battery-support bracket 48 which is arranged below the battery 44.

A DC/DC convertor 50 is disposed between the left-side front seat 21 (seat cushion) and the floor panel 15 (front floor portion 15a). This DC/DC convertor 50 is supported at a specified portion of the floor panel 15 between the front cross member 16 and the rear cross member 17 via a bracket 57 which is provided above the DC/DC convertor 50. A front end portion of the bracket 57 is fixed to an upper face of the front cross member, and a rear end portion of the bracket 57 is fixed to the floor panel 15 via a support portion, not illustrated, which is provided to project on the upper face of the floor panel 15. Thus, the DC/DC convertor 50 is supported at the floor panel in a state in which it is positioned above and away from the floor panel 15 (front floor portion 15a). Thereby, a gap is formed between a heat sink, not illustrated, which is provided at a lower face of the DC/DC convertor 50 and the floor panel 15, so that heat generated by the DC/DC convertor 50 can be sufficiently radiated from the heat sink. Herein, the bracket 57 can also protect the DC/DC convertor 50 from a tip of a foot of a passenger seated in the rear seat 22 when the foot comes into a space between the front seat 21 (seat cushion) and the floor panel 15.

While an operational state and a stop state of the DC/DC convertor 50 is switchable by the control of the controller 70, the DC/DC convertor 50 is basically controlled in the operational state during an ON state of an ignition switch of the vehicle 1.

FIG. 2 shows electricity-connection relationships of the generator 41, the electricity-storage device 43, the battery 44, the DC/DC convertor 50 and a vehicle electric load 45.

During the deceleration of the vehicle 1, the generator 41 is controlled in the generation state by the controller 70, thereby converting the kinetic energy of the vehicle 1 to the electric energy (the generated electricity). The generated electricity (recovered electricity) is stored at the capacitor of the electricity-storage device 43 (hereinafter, referred to as “capacitor” simply). That is, the capacitor charges the electric energy supplied from the generator 41. Further, the generator 41 is also controlled in the electricity-generation state by the controller 70 when the charge amount of the capacitor decreases (the voltage detected by a voltage detector 61 decreases below a standard voltage), thereby storing the generated electricity at the capacitor. Then, the capacitor discharges the electricity stored to the vehicle electric load 45. The vehicle electric load 45 is, for example, an audio device, a navigation device, an illumination device, or the like. Further, the extra electricity which has not been consumed by the vehicle electric load 45 is supplied to and stored at the battery 44 to supply the electricity to the vehicle electric load 45.

The electricity supply to the vehicle electric load 45 from the capacitor is conducted via the DC/DC convertor 50. The DC/DC convertor 50 lowers the voltage of the electricity supplied from the capacitor (or the generator 41) and supply the electricity to the battery 44 and the vehicle electric load 45. That is, since the voltage (the charged voltage of the generator 41 to the capacitor) on the side of the generator 41 and the capacitor is higher than that (12-14V) on the side of the battery 44 and the vehicle electric load 45, this kind of DC/DC convertor 50 is provided. This is because being higher charge voltage of the capacitor by the generator 41 may improve the efficiency of the charging and increase the storage capacitance. The charge voltage of the capacitor by the generator 41 (the electricity-generation voltage by the generator 41) is set at a specified voltage between an upper-limit voltage, which will be described below, and a lower-limit voltage which is slightly higher than the voltage on the side of the battery 44 and the vehicle electric load 45.

A voltage detector 61 and a temperature detector 62 are provided at the electricity-storage device 43. The voltage detector 61 detects the voltage of the capacitor. The voltage of the capacitor is equal to the charge voltage of the capacitor by the generator 41 (the electricity-generation voltage by the generator 41) during charging of the capacitor by the generator 41, whereas it is equal to the discharge voltage during discharging from the capacitor. The temperature detector 62 detects the temperature of the capacitor.

The controller 70 is comprised of a well-known microcomputer, and includes a central processing unit (CPU) executing programs, a memory which is comprised of RAM and ROM, for example, and stores programs and data, and an interface for input/output of various signals.

To the controller 70 are inputted detection information from the voltage detector 61 and the temperature detector 62 as well as a vehicle speed sensor (not illustrated) to detect a vehicle speed of the vehicle 1, an accelerator angle sensor (not illustrated) to detect an accelerator-opening angle which corresponds to an operational amount of an accelerator of the vehicle 1, a brake sensor (not illustrated) to detect pressing of a brake pedal of the vehicle 1, and the like. The controller 70 controls operations of the generator 41 and the DC/DC convertor 50 based on the input information.

The capacitor tends to deteriorate gradually through its use (charging and discharging) (the capacitance decreases, particularly), and this deterioration of the capacitor may be more quickened when the electricity-generation voltage by the generator 41 (the voltage (charge voltage) applied to the capacitor by the generator 41) is higher. In particular, when the electricity-generation voltage by the generator 41 exceeds the specified voltage, the deterioration of the capacitor may be quickened considerably. Therefore, the controller 70 is operated to lower the upper-limit voltage of the charging of the capacitor by the generator 41 (the electricity-generation voltage) when the deterioration of the capacitor may occur before the estimated deterioration, thereby delaying the deterioration of the capacitor.

Specifically, the controller 70 includes an estimated-deterioration degree memorizing module 70a to previously memorize an estimated-deterioration degree of the capacitor against a use term, a real-deterioration degree detecting module 70b to detect a real-deterioration degree of the capacitor at a specified timing of the use term of the capacitor (every a specified period of time in the present embodiment), a deterioration degree determining module 70c, and an upper-limit voltage controlling module 70d.

The estimated-deterioration degree memorizing module 70a memorizes, as the estimated-deterioration degree, an estimated value ΔCa which corresponds to how much the capacitance of the capacitor decreases from its initial value in accordance with the lapse of time after the start of use of the capacitor in the present embodiment. This estimated value ΔCa is a predetermined value through an experiment of repeating charging and discharging which is conducted to the capacitor. If the deterioration of the capacitor progresses according to this estimated-deterioration degree, the capacitor may function properly until the term of guarantee has expired. Accordingly, the above-described upper-limit voltage is set every the above-described specified period of time as described below so that the real-deterioration degree may not exceed the estimated-deterioration degree. That is, it can be said that the estimated-deterioration degree is a target deterioration degree. Herein, while it is preferable that the above-described specified period of time be a few days or about one week, several months or about one year may be also fine.

The real-deterioration degree detecting module 70b detects the real-deterioration degree of the capacitor in a manner described below. That is, the real-deterioration degree detecting module 70b performs a real-deterioration detection mode at the timing of the above-described specified period of time (when the lapse time from the start of use of the capacitor becomes t). This real-deterioration detection mode is a specified mode in which the generator 41 is switched to the non-electricity-generation state, thereby discharging from the capacitor to a register (resistance value R), not illustrated. In this mode, the DC/DC convertor 50 is in the stop state, so that the electricity is supplied to the vehicle electric load from the battery 44.

The real-deterioration degree detecting module 70b inputs the voltages which are detected by the voltage detector 61 at two timings away from each other by a specified time tw during the above-described discharging to the resistance. The detected voltage at the initial timing is V1, and the detected voltage at the later timing is V2. The detected voltage during the discharging lowers in accordance with the lapse of time, so V2 is smaller than V1 (V2<V1). The real-deterioration detecting module 70b calculates the capacitance C of the capacitor by the following equation.

C=−(tw/R)·[1/ln (V2/V1)]

Herein, ln is the natural logarithm, and ln (V2/V1) is a negative number.

The real-deterioration degree detecting module 70b obtains a decrease value ΔCb(t) (=C0−C) which corresponds to how much the above-described capacitance C decreases from the initial value C0 at the above-described specified timing (the lapse time (t) after the start of use of the capacitor). In the present embodiment, this decrease value ΔCb(t) is detected as the real-deterioration degree.

The above-described deterioration degree determining module 70c determines whether or not the real-deterioration degree exceeds the estimated-deterioration degree by comparing the real-deterioration degree which is detected by the real-deterioration degree detecting module 70b with the estimated-deterioration degree which is memorized by the estimated-deterioration degree memorizing module 70a and corresponds to the detection timings of the real-deterioration degree at each of the detection timings of the real-deterioration degree of the capacitor by the real-deterioration detecting module 70b.

Specifically, the deterioration degree determining module 70c inputs the decrease value ΔCb(t) from the estimated-deterioration degree memorizing module 70a, and also inputs an estimated value ΔCa(t) which corresponds to the memorized estimated value ΔCa at the detection timing (the lapse time (t) after the start of use of the capacitor) of the decrease value ΔCb(t) from the real-deterioration degree detecting module 70b. Then, in the present embodiment, the deterioration degree determining module 70c obtains ΔCa(t)/t (=α(t)) as well as ΔCb(t)/t (=β(t)). A value of β(t)), in a graph having the axis of abscissas of time and the axis of ordinates of the capacitor's capacitance, corresponds to an inclination (negative value) of a straight line (L1, L2, L3 in FIG. 4) which shows a change of the capacitance of the capacitor in a specified period of time (t) from the start of use of the capacitor to a present timing when the real-deterioration degree is detected. A value of αa(t) corresponds to the inclination of the estimated value ΔCa(t). A case in which β(t) is greater than a(t) means that the deterioration of the capacitor is quickened before the estimated deterioration (deterioration target) (that is—the real-deterioration degree exceeds the estimated-deterioration degree).

It is determined that the real-deterioration degree exceeds the estimated-deterioration degree when β(t) is greater than α(t). Meanwhile, it is determined that the real-deterioration degree does not exceed the estimated-deterioration degree when β(t) is α(t) or smaller. Herein, comparison of ΔCa(t) with ΔCb(t) or comparison of ΔCa(t)/CO with ΔCb(t)/CO (a rate of the decrease value to the initial value) may be also applied instead of the comparison of α(t) with β(t).

The upper-limit voltage controlling module 70d sets the upper-limit voltage of charging of the capacitor by the generator 41 (the upper-limit voltage of electricity-generation by the generator 4) at a specified voltage when it is determined by the deterioration degree determining module 70c that the real-deterioration degree does not exceed the estimated-deterioration degree. The above-described specified voltage is a voltage having a value (25V, for example) which can considerably quicken the deterioration of the capacitor when the upper-limit voltage exceeds this specified voltage.

Meanwhile, the upper-limit voltage controlling module 70d sets the upper-limit voltage of charging of the capacitor by the generator 41 at a limit voltage which is lower than the above-described specified voltage and corresponds to an excess degree of the real-deterioration degree over the estimated-deterioration degree when it is determined by the deterioration degree determining module 70c that the real-deterioration degree exceeds the estimated-deterioration degree. The above-described limit voltage is a voltage having a value which is obtained by multiplying the above-described specified voltage by a deterioration ratio ω(t) in the present embodiment. This deterioration ratio ω(t) is α(t)/β(t), and when β(t) is greater than α(t) (when it is determined that the real-deterioration degree exceeds the estimated-deterioration degree), the deterioration ratio ω(t) is less than 1 and becomes smaller as β(t) becomes greater. Accordingly, the limit voltage is smaller than the specified voltage, and becomes smaller as the excess of the real-deterioration degree over the estimated-deterioration degree becomes greater.

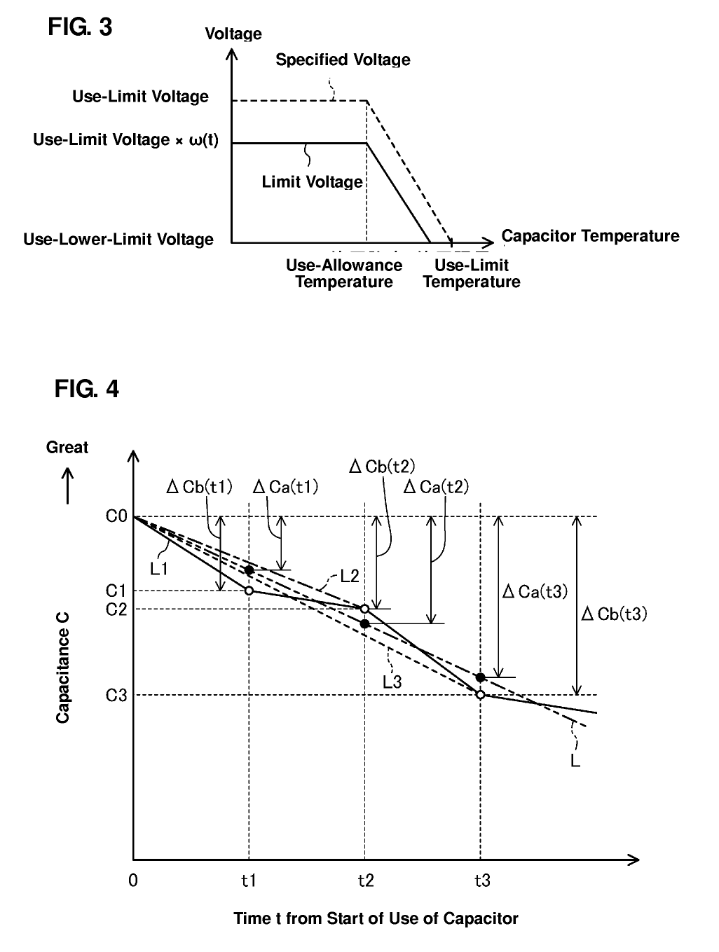

The specified voltage and the limit voltage are changed in accordance with the temperature (the temperature of the capacitor) detected by the temperature detector 62. That is, the upper-limit voltage controlling module 70d includes a characteristic map of the specified voltage for the temperature of the capacitor (see a broken line of FIG. 3), and changes the specified voltage based on the temperature detected by the temperature detector 62 and this characteristic map of the specified voltage (in an example of FIG. 3, when the capacitor's temperature is a use-allowance temperature or smaller which may not influence the capacitor's deterioration, the specified voltage is constant and equal to a use-limit voltage, whereas, when the capacitor's temperature is within a range from the use-allowance temperature to a use-limit temperature which may influence the capacitor's deterioration greatly, the specified voltage is set in accordance with the temperature). The upper-limit voltage controlling module 70d creates a characteristic map of the above-described limit voltage for the capacitor's temperature from the above-described characteristic map of the specified voltage in accordance with the excess degree of the real-deterioration degree over the estimated-deterioration degree when it is determined by the deterioration degree determining module 70c that the real-deterioration degree exceeds the estimated-deterioration degree. Specifically, this characteristic map (see a solid line of FIG. 3) of the limit voltage is created by multiplying the specified voltage corresponding to the respective temperatures in the characteristic map of the specified voltage by the value of the deterioration ratio ω(t) (<1). The upper-limit voltage controlling module 70d changes the limit voltage based on the temperature detected by the temperature detector 62 and this characteristic map of the limit voltage (in the example of FIG. 3, the limit voltage is constant and equal to the use-limit voltage×x ω(t) when the capacitor's temperature is the above-described use-allowance temperature or smaller).

The controller 70 controls the operation of the generator 41 so that the upper-limit voltage of the electricity generation by the generator 41 can be the upper-limit voltage (the specified voltage or the limit voltage) set by the upper-limit voltage controlling module 70d.

An example of the change of the capacitance (the real-deterioration degree) by the operation of the controller described above is shown in FIG. 4. In this example of FIG. 4, regarding the estimated-deterioration memorized at the estimated-deterioration degree memorizing module 70a, the capacitance of the capacitor decreases from the start of use of the capacitor along the straight line L (a two-dotted broken line), and the real-deterioration degree decreases as shown by a solid line.

Each time the lapse time t from the start of use of the capacitor reaches t1, t2 (=2t1), t3 (=3t1) . . . , the real-deterioration degree is detected by the real-deterioration degree detecting module 70b. The upper-limit voltage of charging of the capacitor by the generator 41 is set at the above-described specified voltage until the first detection timing t1 of the real-deterioration degree.

Herein, let's suppose that the capacitance of the capacitor is C1 and the decrease value is ΔCb(t1) (=C0−C1) at the timing t1. The value of the decrease value ΔCb(t1) is greater than the estimated value ΔCa(t1) corresponding to this detection timing That is, the inclination β(t1) of the straight line L1 connecting a coordinates point (0, C0) and a coordinates point (t1, C1) (=ΔCb(t1)/t1) is greater than the inclination α(t1) of the straight line L (=ΔCa(t1)/t1), and the deterioration of the capacitor is quickened before the estimated deterioration (the target deterioration).

The deterioration degree determining module 70c determines from β(t1) being greater than α(t1) that the real-deterioration degree exceeds the estimated-deterioration degree. Thereby, the upper-limit voltage controlling module 70d creates the characteristic map of the limit value from the characteristic map of the specified voltage, and sets the limit voltage based on the capacitor's temperature and the characteristic map of the limit voltage. The above-described limit voltage has a value which is obtained by multiplying the specified voltage by the deterioration ratio ω(t1).

Thus, the upper-limit voltage of charging of the capacitor by the generator 41 (the upper-limit voltage of electricity-generation by the generator 41) is set to be the limit voltage lower than the above-described specified voltage, so that the deterioration of the capacitor can be delayed after the estimated deterioration (the target deterioration).

Herein, when it is determined that the real-deterioration degree does not exceed the estimated-deterioration degree at the timing t1, the above-described upper-limit voltage is made to remain at the above-described specified voltage.

Then, let's suppose that the capacitance of the capacitor is C2 and the decrease value is ΔCb(t2) (=C0−C2) at the next detection timing t2 of the real-deterioration degree. The value of the decrease value ΔCb(t2) is smaller than the estimated value ΔCa(t2) corresponding to this detection timing. That is, the inclination β(t2) of the straight line L2 connecting the coordinates point (0, C0) and a coordinates point (t2, C2) (=ΔCb(t2)/t2) is smaller than the inclination α(t2) of the straight line L (=ΔCa(t2)/t2), and the deterioration of the capacitor is delayed after the estimated deterioration (the target deterioration). This is because that the deterioration of the capacitor is delayed by limiting the upper-limit voltage of charging of the capacitor by the generator 41 to the limit voltage. In the example of FIG. 4, α(t2)=α(t1).

The deterioration degree determining module 70c determines from β(t2) being smaller than α(t2) that the real-deterioration degree does not exceed the estimated-deterioration degree.

The upper-limit voltage controlling module 70d sets the upper-limit voltage to the specified voltage when it is determined at this timing (the timing t2) by the deterioration-degree determining module 70c that the real-deterioration degree does not exceed the estimated-deterioration degree in a case in which it is determined at the previous detection timing (the timing t1) by the deterioration-degree determining module 70c that the real-deterioration degree exceeds the estimated-deterioration degree, thereby the upper-limit voltage is set at the limit voltage.

Herein, when it is determined by the deterioration-degree determining module 70c that the real-deterioration degree exceeds the estimated-deterioration degree, the upper-limit voltage is set at the limit voltage. However, in this case, the limit voltage becomes a value which is obtained by multiplying the specified voltage by the deterioration ratio ω(t2) (=α(t2)/β(t2)).

Further, let's suppose that the capacitance of the capacitor is C3 and the decrease value is ΔCb(t3) (=C0−C3) at the next detection timing t3 of the real-deterioration degree. The value of the decrease value ΔCb(t3) is, like the case of the detection timing t1, greater than the estimated value ΔCa(t3) corresponding to this detection timing. That is, the inclination β(t3) of the straight line L3 connecting the coordinates point (0, C0) and a coordinates point (t3, C3) (=ΔCb(t3)/t3) is greater than the inclination α(t3) of the straight line L (=ΔCa(t3)/t3), and the deterioration of the capacitor is quickened before the estimated deterioration (the target deterioration). In the example of FIG. 4, α(t3)=α(t2)=α(t1).

The deterioration degree determining module 70c determines from β(t3) being greater than α(t3) that the real-deterioration degree exceeds the estimated-deterioration degree. Thereby, the upper-limit voltage controlling module 70d creates the characteristic map of the limit value from the characteristic map of the specified voltage, and sets the limit voltage based on the capacitor's temperature and the characteristic map of the limit voltage. The above-described limit voltage has a value which is obtained by multiplying the specified voltage by the deterioration ratio ω(t3) (=α(t3)/β(t3)).

According to the present embodiment, since the upper-limit voltage of the charging of the capacitor is set at the limit voltage lower than the specified voltage of the case in which it is determined that the real-deterioration degree does not exceed the estimated-deterioration degree when it is determined by the deterioration degree determining module 70c that the real-deterioration degree exceeds the estimated-deterioration degree, the deterioration of the capacitor can be delayed after the estimated deterioration. Further, since the limit voltage is the voltage corresponding to the excess degree of the real-deterioration degree over the estimated-deterioration degree, it can be controlled at an appropriate voltage enabling the capacitor's deterioration to be delayed after the estimated deterioration, without being lowered excessively. Accordingly, the capacitor's deterioration can be delayed, keeping a properly-high efficiency of the charging of the capacitor. Further, since the upper-limit voltage is set at the above-described specified voltage when it is determined by the deterioration degree determining module 70c that the real-deterioration degree does not exceed the estimated-deterioration degree, the charging efficiency of the capacitor can be increased. Thereby, the durability of the capacitor can be improved, improving the fuel economy of the vehicle 1.

The present invention should not be limited to the above-described embodiment, and any other modifications or improvements may be applied within the scope of a sprit of the present invention.

For example, while the capacitance of the capacitor is used as an element to determine the deterioration degree in the above-described embodiment, the internal resistance may be used as the element of the deterioration-degree determination because the internal resistance shows a similar tendency.

While the specified voltage and the limit voltage are changed in accordance with the temperature detected by the temperature detector 62 (the capacitor's temperature) in the above-described embodiment, either one of the specified voltage and the limit voltage may be set at a constant voltage regardless of the temperature of the capacitor.

What is claimed is:

1. A control device of a vehicle-onboard electric source, comprising:
a generator driven by an engine to generate electricity;
a capacitor storing an electric energy from the generator during declaration of a vehicle to discharge the electricity to an electric load of the vehicle; and
a controller including:
an estimated-deterioration degree memorizing module configured to previously memorize an estimated-deterioration degree of the capacitor against a use term;
a real-deterioration degree detecting module configured to detect a real-deterioration degree of the capacitor at a specified timing of the use term of the capacitor;
a deterioration degree determining module configured to determine whether or not the real-deterioration degree exceeds the estimated-deterioration degree by comparing the real-deterioration degree detected by said real-deterioration degree detecting module and the estimated-deterioration degree memorized by said estimated-deterioration degree memorizing module; and
an upper-limit voltage controlling module configured to set an upper-limit voltage of charging of said capacitor by said generator at a limit voltage which is lower than a specified voltage and corresponds to an excess degree of the real-deterioration degree over the estimated-deterioration degree when it is determined by said deterioration degree determining module that the real-deterioration degree exceeds the estimated-deterioration degree.

2. The control device of a vehicle-onboard electric source of claim 1, wherein said upper-limit voltage controlling module is configured to set the upper-limit voltage at said specified voltage when it is determined by said deterioration degree determining module that the real-deterioration degree does not exceed the estimated-deterioration degree.

3. The control device of a vehicle-onboard electric source of claim 2, further comprising a capacitor-temperature detector to detect a temperature of said capacitor, wherein said upper-limit voltage controlling module is configured to change said limit voltage in accordance with the temperature detected by said capacitor-temperature detector when it is determined by said deterioration degree determining module that the real-deterioration degree exceeds the estimated-deterioration degree.

4. The control device of a vehicle-onboard electric source of claim 3, wherein said upper-limit voltage controlling module has a characteristic map of said specified voltage according to the temperature of the capacitor, and is configured, when it is determined by said deterioration degree determining module that the real-deterioration degree exceeds the estimated-deterioration degree, to create a characteristic map of said limit voltage according to the temperature of the capacitor from said characteristic map of the specified voltage in accordance with the excess degree of the real-deterioration degree over the estimated-deterioration degree, and change said limit voltage based on said temperature detected by the capacitor-temperature detector and said characteristic map of the limit voltage.

5. The control device of a vehicle-onboard electric source of claim 1, further comprising a capacitor-temperature detector to detect a temperature of said capacitor, wherein said upper-limit voltage controlling module is configured to change said limit voltage in accordance with the temperature detected by said capacitor-temperature detector when it is determined by said deterioration degree determining module that the real-deterioration degree exceeds the estimated-deterioration degree.

6. The control device of a vehicle-onboard electric source of claim 5, wherein said upper-limit voltage controlling module has a characteristic map of said specified voltage according to the temperature of the capacitor, and is configured, when it is determined by said deterioration degree determining module that the real-deterioration degree exceeds the estimated-deterioration degree, to create a characteristic map of said limit voltage according to the temperature of the capacitor from said characteristic map of the specified voltage in accordance with the excess degree of the real-deterioration degree over the estimated-deterioration degree, and change said limit voltage based on said temperature detected by the capacitor-temperature detector and said characteristic map of the limit voltage.

7. The control device of a vehicle-onboard electric source of claim 1, wherein said real-deterioration degree detecting module is configured to repeat said detection of the real-deterioration degree of the capacitor every a specified period of time, said deterioration degree determining module is configured to conduct said determination as to whether or not the real-deterioration degree exceeds the estimated-deterioration degree at each time of said detection of the real-deterioration degree of the capacitor by the real-deterioration degree detecting module, and said upper-limit voltage controlling module is configured to set said upper-limit voltage at said specified voltage when, in a previous determination, it is determined by said deterioration degree determining module that the real-deterioration degree exceeds the estimated-deterioration degree, thereby setting the upper-limit voltage at the limit voltage, and then, in a present determination, it is determined by said deterioration degree determining module that the real-deterioration degree does not exceed the estimated-deterioration degree.

8. The control device of a vehicle-onboard electric source of claim 2, wherein said real-deterioration degree detecting module is configured to repeat said detection of the real-deterioration degree of the capacitor every a specified period of time, said deterioration degree determining module is configured to conduct said determination as to whether or not the real-deterioration degree exceeds the estimated-deterioration degree at each time of said detection of the real-deterioration degree of the capacitor by the real-deterioration degree detecting module, and said upper-limit voltage controlling module is configured to set said upper-limit voltage at said specified voltage when, in a previous determination, it is determined by said deterioration degree determining module that the real-deterioration degree exceeds the estimated-deterioration degree, thereby setting the upper-limit voltage at the limit voltage, and then, in a present determination, it is determined by said deterioration degree determining module that the real-deterioration degree does not exceed the estimated-deterioration degree.

9. The control device of a vehicle-onboard electric source of claim 3, wherein said real-deterioration degree detecting module is configured to repeat said detection of the real-deterioration degree of the capacitor every a specified period of time, said deterioration degree determining module is configured to conduct said determination as to whether or not the real-deterioration degree exceeds the estimated-deterioration degree at each time of said detection of the real-deterioration degree of the capacitor by the real-deterioration degree detecting module, and said upper-limit voltage controlling module is configured to set said upper-limit voltage at said specified voltage when, in a previous determination, it is determined by said deterioration degree determining module that the real-deterioration degree exceeds the estimated-deterioration degree, thereby setting the upper-limit voltage at the limit voltage, and then, in a present determination, it is determined by said deterioration degree determining module that the real-deterioration degree does not exceed the estimated-deterioration degree.

10. The control device of a vehicle-onboard electric source of claim 4, wherein said real-deterioration degree detecting module is configured to repeat said detection of the real-deterioration degree of the capacitor every a specified period of time, said deterioration degree determining module is configured to conduct said determination as to whether or not the real-deterioration degree exceeds the estimated-deterioration degree at each time of said detection of the real-deterioration degree of the capacitor by the real-deterioration degree detecting module, and said upper-limit voltage controlling module is configured to set said upper-limit voltage at said specified voltage when, in a previous determination, it is determined by said deterioration degree determining module that the real-deterioration degree exceeds the estimated-deterioration degree, thereby setting the upper-limit voltage at the limit voltage, and then, in a present determination, it is determined by said deterioration degree determining module that the real-deterioration degree does not exceed the estimated-deterioration degree.

11. A control device of a vehicle-onboard electric source, comprising:
a generator driven by an engine to generate electricity;
a capacitor storing an electric energy from the generator during declaration of a vehicle to discharge the electricity to an electric load of the vehicle; and
a controller configured to perform the process of:
previously memorizing an estimated-deterioration degree of the capacitor against a use term;
detecting a real-deterioration degree of the capacitor at a specified timing of the use term of the capacitor;
determining whether or not the real-deterioration degree exceeds the estimated-deterioration degree by comparing the real-deterioration degree detected with the estimated-deterioration degree; and
setting an upper-limit voltage of charging of said capacitor by said generator at a limit voltage which is lower than a specified voltage and corresponds to an excess degree of the real-deterioration degree over the estimated-deterioration degree when it is determined that the real-deterioration degree exceeds the estimated-deterioration degree.
